(19) United States
(12) Patent Application Publication
(10) Pub. No.: US 2004/0071615 A1
(43) Pub. Date: Apr. 15, 2004

(54) Ozone generator

(76) Inventors: Robert G. Khatchatrian, Glendale, CA (US); Ashot P. Khatchatrian, Glendale, CA (US); Asmik Aruntyunyan, Glendale, CA (US); Morev Sergey Nikolaevich, Novosibirsk (RU)

Correspondence Address: KNOBBE MARTENS OLSON & BEAR LLP, 2040 MAIN STREET, FOURTEENTH FLOOR, IRVINE, CA, 92614, US

(21) Appl. No.: 10/456,974

(22) Filed: Jun. 5, 2003

Related U.S. Application Data
(63) Continuation of application No. 09/397,749, filed on Sep. 16, 1999, now abandoned.
Application No. 09/397,749 is a continuation-in-part of application No. 09/317,362, filed on May 24, 1999, now abandoned.
Application No. 09/317,362 is a continuation of application No. 08/956,709, filed on Oct. 23, 1997, now Pat. No. 5,911,957.

(51) Int. Cl. B01J 19/08

(52) U.S. Cl. 422/186.12; 604/25; 422/5; 422/29; 34/283

(57) ABSTRACT

The present invention relates to various forms of ozone generator having a discharge means and a reflecting screen and methods for their application. The discharge means is a rough-surfaced dielectric element with central aperture and rectangular cross-section sandwiched between a first electrode and a second electrode. The first electrode is a plurality of helical windings that contact a plurality of flanges on the dielectric element and the second electrode is an electrically conductive coating which overlies the rough surface of the dielectric element. One form of the ozone generator has a central unit and two side units, where the side units can be rotated to form various shapes. The various shapes of the ozone generator can be used for room deodorizing, clothes freshening, and shoe deodorizing. Other applications for various forms of the ozone generator include treating and maintaining hair of humans and pets, room deodorizing, and shoe deodorizing. Other forms of electrode can be used in the various forms of the ozone generator, including electrodes in the shape of a ring and a plate with a sharpened tip and electrodes in the shape of a filament and a plate with an elongated slot.

This application is a continuation-in-part of application Ser. No. 09/317,362, filed May 24, 1999, which is a continuation of application Ser. No. 08/956,709, filed Oct. 23, 1997, now U.S. Pat. No. 5,911,957.

### BACKGROUND OF THE INVENTION

Ozone is a powerful oxidizing agent that has many industrial and household uses. Ozone effectively kills bacteria, inhibits fungal growth, and inactivates many viruses, cysts, and spores. In addition, soaps, oils, and chloramines can be rendered environmentally safe by ozone treatment. The antiseptic properties of ozone are useful for water purification, room sanitation, equipment sterilization, and food preservation.

There are several known methods for producing ozone from air or other oxygen-containing gases. A number of these processes generate ozone by passing an oxygen-containing gas between two electrodes, separated by a dielectric material—the oxygen is converted to ozone as it travels through the electrical discharge. Ozone has a half-life of only about 22 minutes at ambient temperatures, and at higher temperatures the rate of ozone decay is accelerated. An efficient ozone generator should, therefore, produce a high concentration of ozone without generating appreciable heat.

To this aim, several modifications on the basic corona discharge ozone generator have been developed. U.S. Pat. No. 5,409,673 relates to an ozone generator characterized by an outer electrode overlying a portion of a dielectric tube filled with a mass of helical windings which serves as an inner electrode. Similarly, U.S. Pat. No. 5,554,344 teaches the enhancement of ozone production by employing electrodes with a jagged surface while U.S. Pat. No. 4,981,656 teaches that an electrode of polygonal shape provides uniform gas discharge at low electrical voltages. Furthermore, with regard to heat dissipation, U.S. Pat. No. 4,770,858 teaches the benefits of coating the surface of a dielectric tube with non-conductive particles of inorganic material.

Despite the numerous beneficial applications for ozone and repeated attempts in the prior art to invent an efficient ozone generator, such a discovery has not yet occurred. The failure of the prior art to provide an efficient ozone generator can be attributed to three persistent problems: improperly aligned electrodes, accumulation of heat generated by the electrical discharge, and the lack of a means to direct freshly made ozone away from the apparatus to a site intended for treatment. The need for a simple and compact apparatus which efficiently produces and rapidly disperses ozone without accumulating an appreciable amount of heat is manifest.

### SUMMARY OF THE INVENTION

One aspect of the invention concerns an apparatus for generating ozone, where the apparatus comprises a housing comprising a central unit and two lateral units attached to the central unit through rotatable joints. The apparatus also comprises a discharge means in at least one of the lateral units, where the discharge means comprises a dielectric element of rectangular cross-section having a rough surface, a plurality of flanges joined to the dielectric element, a first electrode comprised of a plurality of electrically conductive helical windings in contact with the flanges, a second electrode comprised of an electrically conductive coating which overlies the rough surface of the dielectric element, and a power supply connected to the first and second electrodes. The lateral units rotate on the rotatable joints to form ozone generators having different shapes and functions.

In one embodiment of the apparatus, the lateral units are rotated close to the central unit to form an ozone generator for room deodorizing. In another embodiment, the apparatus additionally comprises a hook on the central unit, and the lateral units are rotated outward from the central unit to form an ozone generator in the shape of a clothes hanger for clothes freshening. In another embodiment of the invention, the lateral units are rotated forward to form an ozone generator which can be inserted into shoes for freshening and deodorizing the shoes. In an embodiment of the invention, there are discharge means in both of the lateral units.

Another aspect of the invention concerns a method for treating hair on the head of a human with an ozone generator comprising a dielectric element of rectangular cross-section with a rough surface. The ozone generator also comprises a plurality of flanges joined to the dielectric element, a first electrode with a plurality of electrically conductive helical windings in contact with the flanges, a second electrode which is an electrically conductive coating on the rough surface of the dielectric element, and a tubular shaped reflecting screen, where the tubular shaped screen is connected to an inlet that can be attached to a source of oxygen containing gas. The tubular shaped screen is also connected to an intermediate unit, which is attached to a cap. The cap is placed over the hair, a source of an oxygen containing gas is connected to the inlet, and the electrodes are energized with electrical power to generate an electrical discharge. The oxygen containing gas passes through the electrical discharge to generate ozone, which passes through the intermediate unit into the cap and over the hair, treating the hair.

Another aspect of the invention concerns a method for hair maintenance comprising providing an ozone generator comprising a dielectric element of rectangular cross-section with a rough surface, a plurality of flanges joined to the dielectric element, and an electrode comprising a plurality of electrically conductive helical windings in contact with the flanges. The ozone generator also comprises a second electrode which is an electrically conductive coating on the rough surface of the dielectric element and a tubular shaped reflecting screen that is connected at one end to an inlet that can be joined to a source of an oxygen containing gas. The screen is connected to an intermediate unit at the other end. A comb is attached to the tubular shaped screen through the intermediate unit, where the comb has one or more channels leading from the intermediate unit to the teeth on the comb. An oxygen-containing gas is joined to the inlet of the screen, the electrodes are energized with electrical power to generate an electrical discharge, and an oxygen containing gas is passed through the electrical discharge to generate ozone, where the ozone passes through the intermediate unit into the channels in the comb and the teeth of the comb. Combing the hair with the comb maintains the hair.

Another aspect of the invention concerns a method for maintaining hair on humans, dogs, or cats comprising providing an ozone generator comprising a dielectric element of rectangular cross-section with a rough surface and a plurality of flanges joined to the dielectric element, where a first electrode made up of a plurality of electrically conductive helical windings is in contact with the flanges. The ozone generator also comprises a second electrode which is an electrically conductive coating on the rough surface of the dielectric element and a tubular shaped reflecting screen that is connected to an inlet that can be joined to a source of an oxygen containing gas. The tubular reflecting screen is also attached to an intermediate unit. A massage brush with flexible massage elements is attached to the end of the tubular screen through the intermediate unit, where one or more channels inside the massage brush extend from the intermediate unit to the flexible massage elements. A source of an oxygen containing gas is attached to the inlet, and the electrodes are energized with electrical power to generate an electrical discharge. An oxygen containing gas is passed through the electrical discharge to generate ozone. The ozone passes through the intermediate unit into the channels inside the massage brush to the flexible massage elements. Brushing the hair with the massage brush maintains the hair.

Another aspect of the invention concerns a method for cleaning or refreshing clothes with an ozone generator comprising a dielectric element of rectangular cross-section having a rough surface and a plurality of flanges joined to the dielectric element. The ozone generator also comprises a first electrode comprising a plurality of electrically conductive helical windings in contact with the flanges. The ozone generator also comprises a second electrode which is an electrically conductive coating on the rough surface of the dielectric element and a tubular shaped reflecting screen that is connected to an inlet that can be joined to a source of an oxygen containing gas. The tubular screen is also attached to an intermediate unit. A clothes brush with flexible cleaning elements is attached to the tubular shaped reflecting screen through the intermediate unit. One or more channels inside the clothes brush extend from the intermediate unit to the flexible cleaning elements. A source of an oxygen containing gas is attached to the inlet of the tubular shaped reflecting screen, and the electrodes are energized with electrical power to generate an electrical discharge. An oxygen containing gas passes through the electrical discharge to generate ozone, where the ozone passes through the intermediate unit into the channels inside the clothes brush to the flexible cleaning elements. Brushing the clothes with the clothes brush cleans or refreshes the clothes.

Another aspect of the invention concerns a method for maintaining hair of men, women, dogs or cat with an ozone generator comprising a dielectric element of rectangular cross-section having a rough surface. A plurality of flanges are joined to the dielectric element. A first electrode comprising a plurality of electrically conductive helical windings is in contact with the flanges. The ozone generator also comprises a second electrode which is an electrically conductive coating on the rough surface of the dielectric element and a tubular shaped reflecting screen that is connected to an inlet that can be joined to a source of an oxygen containing gas. The tubular screen is also attached to an intermediate unit. Flexible cleaning units are attached to the tubular shaped reflecting screen through the intermediate unit. A source of an oxygen containing gas is attached to the inlet of the tubular shaped reflecting screen, and the electrodes are energized with electrical power to generate an electrical discharge. An oxygen containing gas passes through the electrical discharge to generate ozone, and the ozone is supplied to the flexible cleaning elements. Brushing the hair with the flexible cleaning units maintains the hair. Preferably, the ozone generator also comprises a battery power supply and a high voltage converter.

Another aspect of the invention concerns a method for deodorizing a room or refreshing the clothes in a wardrobe with an ozone generator comprising a dielectric element of rectangular cross-section having a rough surface, a plurality of flanges joined to the dielectric element, and an electrode having a plurality of electrically conductive helical windings in contact with the flanges. The ozone generator also comprises a second electrode made up of an electrically conductive coating on the rough surface of the dielectric element, a reflecting screen of parabolic shape attached to the dielectric element, and a hook to suspend the ozone generator on the room wall or in the wardrobe. The method comprises suspending the ozone generator on the room wall or in the wardrobe from the hook, energizing the electrodes with electrical power to generate an electrical discharge, passing an oxygen containing gas through the electrical discharge to generate ozone. Advantageously, the hook is detachable.

Another aspect of the invention concerns a method for deodorizing a room with an ozone generator having a dielectric element of rectangular cross-section having a rough surface, where a plurality of flanges are joined to the dielectric element. The ozone generator also comprises an electrode containing a plurality of electrically conductive helical windings in contact with the flanges, a second electrode made up of an electrically conductive coating on the rough surface of the dielectric element, a reflecting screen of parabolic shape, attached to the dielectric element, and a base for placing the ozone generator on the floor. The ozone generator is placed on the floor in the room, the electrodes are energized with electrical power to generate an electrical discharge; and an oxygen containing gas is passed through the electrical discharge to generate ozone.

Another aspect of the invention concerns a method for sanitizing shoes with an ozone generator with a housing made up of two parallel cylinders, where each cylinder contains a discharge element comprising a dielectric element of rectangular cross-section with a rough surface and a plurality of flanges joined to the dielectric element. A first electrode having a plurality of electrically conductive helical windings is in contact with the flanges. The ozone generator also comprises a second electrode comprising an electrically conductive coating overlying the rough surface of the dielectric element and a reflecting screen of parabolic shape attached to the dielectric element. The ozone generator is placed in the shoes, the electrodes are energized with electrical power to generate an electrical discharge; and an oxygen containing gas is passed through the electrical discharge to generate ozone.

Another aspect of the invention concerns a method for generating ozone for multipurpose use with an ozone generator comprising a housing with a central unit and two lateral units attached to the central unit through rotatable joints. A discharge means is located in at least one of the lateral units, where the discharge means comprises a dielectric element of rectangular cross-section with a rough surface, a plurality of flanges joined to the dielectric element, a first electrode comprising a plurality of electrically conductive helical windings in contact with the flanges, a second electrode made up of an electrically conductive coating on the rough surface of the dielectric element, and a power supply connected to the first and second electrodes. The lateral units rotate on the rotatable joints to form ozone generators having different shapes and functions. The lateral units are rotated to form an ozone generator of the desired configuration, the first and second electrodes are energized with electrical power to generate an electrical discharge, and an oxygen containing gas is passed through the electrical discharge to generate ozone.

Another aspect of the invention concerns an apparatus for generating ozone from an electrical discharge in an oxygen containing gas, where the apparatus comprises a first electrode in the shape of a ring and a second electrode in the shape of a plate with a sharpened tip, where the plate is made from a current-carrying material and where the sharpened tip points toward the ring. Preferably, the apparatus also contains a high frequency generator and a power supply.

Another aspect of the invention concerns an apparatus for generating ozone from an electrical discharge in an oxygen containing gas, where the apparatus comprises a first electrode in the shape of a current-carrying filament and a second electrode in the shape of a plate having an elongated slot, where two elongated strips extend axially from the plate at approximately right angles in a direction away from the first electrode. Preferably, the apparatus also has a high frequency power converter and a power supply.

### BRIEF DESCRIPTION OF THE DRAWINGS

FIG. 1 is a sectional view of a first embodiment of a silent discharge means attached to a HF converter, taken at arrow 1 of FIG. 2.

FIG. 2 is a cross-sectional view of the first embodiment of the silent discharge means.

FIG. 3 is a cross-sectional view of a second embodiment of the discharge means.

FIG. 4 is a perspective view of a first embodiment of an ozone generator according to the present invention (without reflecting screen).

FIG. 5 is a sectional view of a second embodiment of the ozone generator according to the present invention.

FIG. 6 is a sectional view of a third embodiment of the ozone generator according to the present invention.

FIG. 7 is a sectional view of a fourth embodiment of the ozone generator according to the present invention.

FIG. 8 is a sectional view of a fifth embodiment of the ozone generator according to the present invention.

FIG. 9 is a perspective view of a cap which can be attached to the ozone generator of FIG. 4 to provide hair maintenance.

FIG. 10 is a perspective view of a hair comb which can be attached to the ozone generator of FIG. 4.

FIG. 11A is an end view of a massaging hair brush which can be attached to the ozone generator of FIG. 4.

FIG. 11B is a side view of a massaging hair brush which can be attached to the ozone generator of FIG. 4.

FIG. 12A is an end view of a massaging hair brush for maintenance of dog hair which can be attached to the ozone generator of FIG. 4.

FIG. 12B is a side view of a massaging hair brush for maintenance of dog hair which can be attached to the ozone generator of FIG. 4.

FIG. 13A is an end view of a brush which can be attached to the ozone generator of FIG. 4 for freshening of clothes.

FIG. 13B is a side view of a brush which can be attached to the ozone generator of FIG. 4 for freshening of clothes.

FIG. 14A is a perspective view of a ozone generator to which removable attachments may be attached.

FIG. 14B is an end view of a removable attachment which can be attached to the ozone generator of FIG. 14A for maintenance of hair of men or women.

FIG. 14C is a side view of the removable attachment of FIG. 14B.

FIG. 14D is an end view of a removable attachment which can be attached to the ozone generator of FIG. 14A for maintenance of hair of dogs.

FIG. 14E is a side view of the removable attachment of FIG. 14B.

FIG. 14F is an end view of a removable attachment which can be attached to the ozone generator of FIG. 14A for clothes freshening.

FIG. 14G is a side view of the removable attachment of FIG. 14E.

FIG. 15 is a perspective view of a suspendable ozone generator for air freshening in a room or closet.

FIG. 16 is a perspective view of a floor model of an ozone generator for air freshening a room.

FIG. 17 is a perspective view of an ozone generator for deodorizing shoes.

FIG. 18A is a perspective view of a multifunctional ozone generator configured for deodorizing rooms and closets.

FIG. 18B is a perspective view of the multifunctional ozone generator configured for deodorizing clothes.

FIG. 18C is a perspective view of the multifunctional ozone generator configured for deodorizing shoes.

FIG. 19 is a perspective view of a design variant of the discharge elements in the form of a ring and cone.

FIG. 20 is a perspective view of a design variant of the discharge elements in the form of a filament and a plate with an elongated slot.

### DETAILED DESCRIPTION OF THE PREFERRED EMBODIMENTS

The present invention will be described more fully hereinafter with reference to the accompanying drawings, in which preferred embodiments of the invention are shown. This invention may be embodied in many different forms, however, and should not be construed as limited to the embodiments set forth within. Applicants provide these embodiments so that this disclosure will be thorough and complete, and willfully convey the scope of the invention to those skilled in the art.

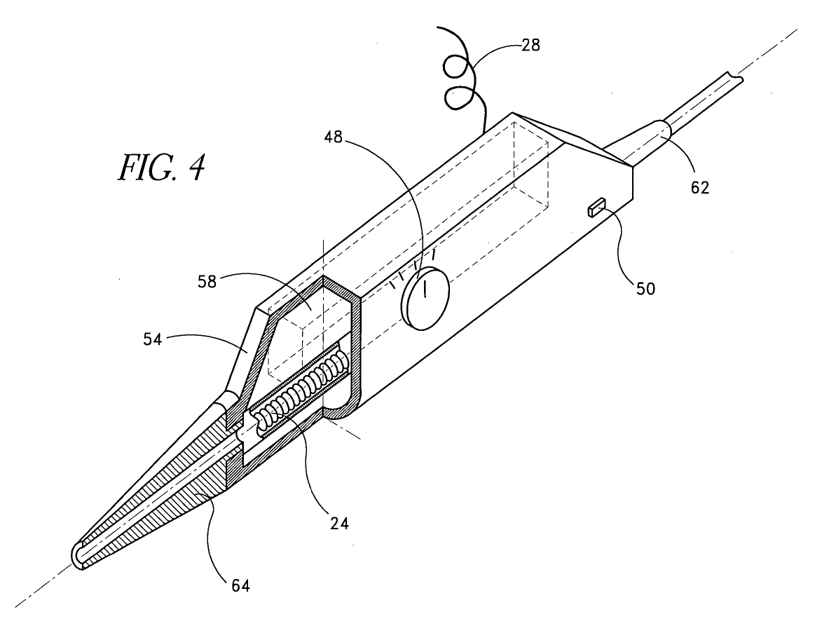

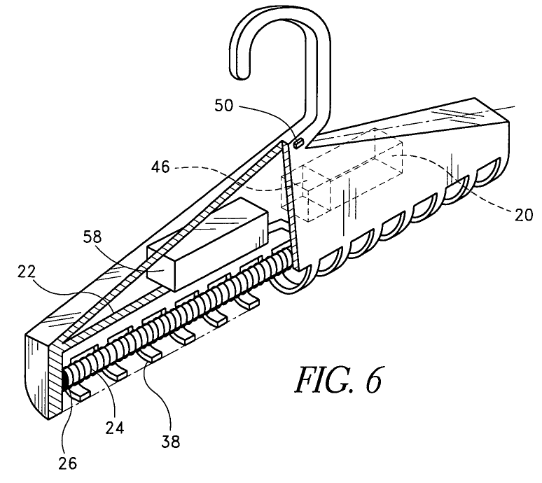

As shown in FIGS. 1-8, an ozone generator is comprised of a discharge means 24 optionally connected to a reflecting screen 22. The discharge means 24 is connected to a high frequency converter (HF converter) 58 which is in turn attached to a power supply 20. The power supply 20 is either a storage battery (FIGS. 6, 8) or normal line current from an electrical network (110 or 220 volts) (FIGS. 4, 5, 7). Optional electrical leads 28 may be used to connect the high frequency converter 58 to the discharge means 24 and the power supply 20. FIGS. 1-3 reveal that the discharge means 24 is comprised of a rough-surfaced dielectric element 34 of rectangular shape, a central aperture 44, a first electrode 32, a second electrode 36, and a plurality of flanges 30. The electrodes 32 and 36 are attached to the high frequency converter (HF converter) 58 which is in turn attached to the power supply 20. The power supply is either a battery or line current from an electrical network.

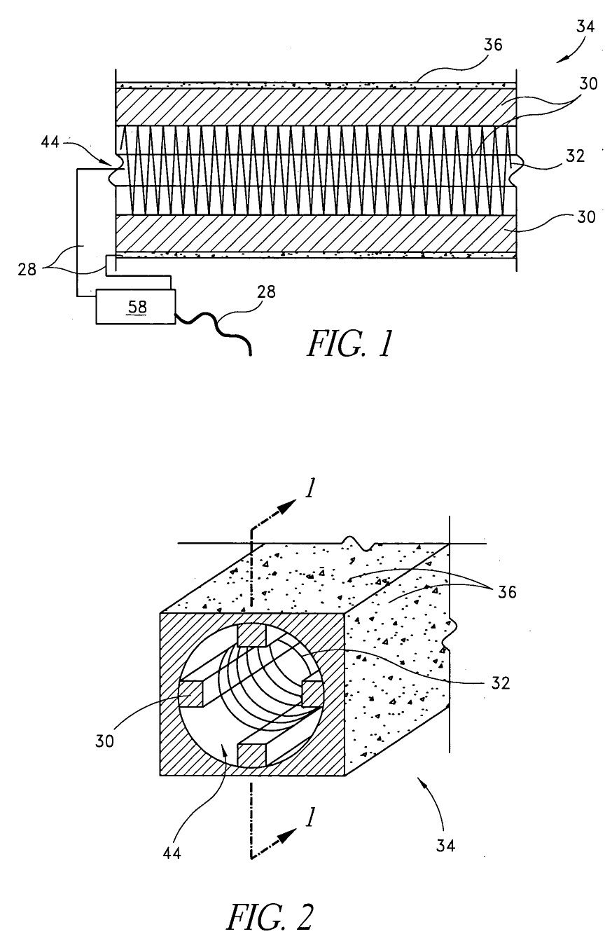

In a first embodiment of the discharge means 24, illustrated in FIGS. 1 and 2, the first electrode 32 is comprised of a plurality of helical windings that are mounted inside the central aperture 44 in an aligned position. Alignment of the first electrode 32 with respect to the central aperture 44, dielectric element 34, and the second electrode 36 is necessary to ensure uniform discharge at low voltages and to reduce the accumulation of heat at the dielectric element 34 and the electrodes 32 and 36. As used in this disclosure, the intended meaning of the word alignment and derivatives thereof encompasses the position of the first electrode 32 with respect to the central aperture 44, the dielectric element 34, and the placement of the first electrode 32 in a manner that maintains a constant distance of separation between the electrodes 32 and 36 along the entire length of the discharge means 24. The rectangular shape of the dielectric element 34 facilitates the determination of the position of the alignment of the first electrode 32, and flanges 30 hold the first electrode 32 in the properly aligned position. The helical windings of the first electrode 32 comprise an spiral shape. The first electrode is held in position inside the dielectric element 34 through the elastic nature or spring-like behavior of the spiral. The first electrode 32 is generally the same length as the dielectric element 34, although a first electrode 32 of any size can be constructed and mounted within a larger-sized dielectric element 34. The first electrode 32 of the first embodiment of the discharge means 24 may have 1 winding per cm to 100 windings per cm, or more desirably 2 windings per cm to 50 windings per square cm, or preferably 2 windings per cm to 20 windings per cm. Similarly, the diameter of the filament used to construct the helical windings for this embodiment may include 0.001 mm to 1 mm, or more desirably 0.01 mm to 0.5 mm, or preferably 0.1 mm to 0.14 mm. The helical windings of the first electrode 32 can be made from tungsten, nickel-chromium alloy, molybdenum, or other suitable metals.

The flanges 30 which hold the first electrode 32 in an aligned position may be part of a single-piece dielectric element 34 or, alternatively, may be comprised of a material different than the dielectric element 34 and attached to the dielectric element 34 by conventional methods. The dimensions of the flanges 30 and their spacing within the central aperture 44 may depend on the type of ozone generator and its intended application. The dielectric element 34 may contain from 4 to 20 flanges 30, or desirably 4 to 10 flanges 30, or preferably 4 to 6 flanges 30.

The second electrode 36 of the first embodiment of the discharge means 24 comprises an electrically conductive coating that overlies the rough outer surface of the dielectric element 34. Suitable electrically conductive coatings include copper, silver, and aluminum, although one of skill in the art would be able to develop and/or use many equivalent coatings to fulfill the intended purpose of this element of the present invention. The electrically conductive coating can be applied by being sprayed or chemically deposited to a thickness of 0.1 microns to 100 microns or more desirably from 0.5 microns to 50 microns or preferably from 2 to 10 microns. The second electrode 36 preferably spans the entire length of the dielectric element 34 or, alternatively, may overlay only a portion of the dielectric element 34.

The dielectric element 34 can be made from ceramic, but it is within the skill of anyone in the art to manufacture a dielectric element from many other suitable materials such as glass or PYREX. Alternatively, the surface of the dielectric element 34 facing the first electrode 32 can be a composite structure constructed of materials having different dielectric permeability and porosity such as ceramic and glass fiber. The thickness of the dielectric element 34 and the dimensions of the central aperture 44 may vary according to the apparatus and intended application, but, in general, the electrodes 32 and 36 are separated by a dielectric element 34 having a thickness of 0.01 mm to 10 mm or, more desirably, 0.05 mm to 2 mm or preferably 0.1 mm to 0.7 mm, and the central aperture 44 can have a diameter of 0.1 mm to 20 mm, more preferably 1 mm to 10 mm, and most preferably from 2 mm to 6 mm.

The dielectric element 34 has a rough surface which serves as the foundation for the second electrode 36 once the dielectric element 34 is overlaid with the electrically conductive coating serving as the second electrode 36. The rough surface on the dielectric element 34 can be made by sanding, chemical treatment, or by embedding the surface with electrically conductive or electrically non-conductive particles. Particles suitable for embedding the surface of the dielectric element are glass or ceramic, but many equivalent particles would be known by one of skill in the art. Furthermore, there are many ways to create a dielectric element 34 with a rough surface and any person of skill in the art could develop alternative means to fulfill this purpose of the invention. Discharge at low voltages is improved by the rough surface of the second electrode 36, and the intimate association of the second electrode 36 with the dielectric element 34 enables the rapid dispersion of heat generated by the discharge means 24.

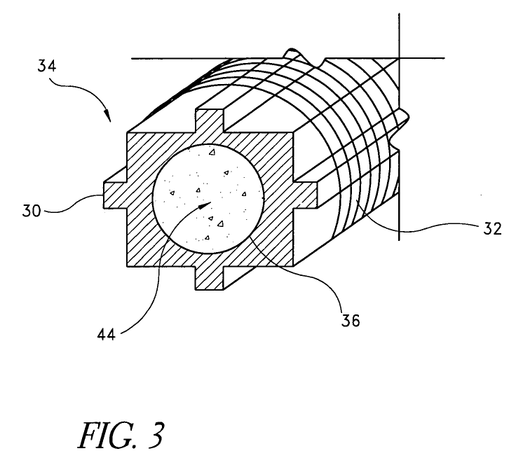

The construction of the first embodiment of the discharge means 24 can be used to guide one of skill in the art to make and use the second embodiment of the discharge means 24, illustrated in FIG. 3. In the second embodiment, however, the first electrode 32 spirals around the outside of the dielectric element 34, and the dielectric element 34 has a central aperture 44 with a rough interior surface. Furthermore, the electrically conductive coating of the second electrode 36 overlies the rough surface inside the central aperture 44. The first electrode 32 is aligned with respect to the central aperture 44 and the second electrode 36, and flanges secure the first electrode 32 to the dielectric element 34 in the aligned position. The first electrode 32 of the second embodiment of the discharge means 24 may have 1 winding per cm to 100 windings per cm, or more desirably 2 windings per cm to 50 windings per cm, or preferably 2 windings per cm to 20 windings per cm. Similarly, the filament used to construct the helical windings for this embodiment has a diameter of 0.001 mm to 1 mm, or more desirably 0.01 mm to 0.5 mm, or preferably 0.1 mm to 0.14 mm. The helical windings of the first electrode may be made from tungsten, nickel-chromium alloy, molybdenum, or other suitable metals.

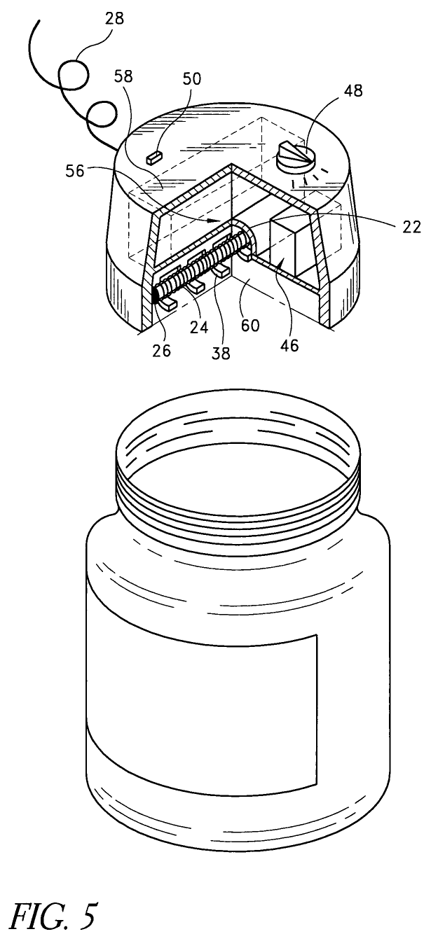

The fabrication of reflecting screens 22 to accompany the embodiments illustrated in FIGS. 5-8 can be accomplished through routine experimentation by one of skill in the art given the disclosure that follows. Reflecting screens 22 are generally made from plastic or metal, but they can also be constructed from many other materials known to those of skill in the art. In FIG. 5, the reflecting screen 22 is a parabolic shape, and the dielectric element 34 of the discharge means 24 is joined to the reflecting screen 22 by a plurality of mounting brackets 26. Mounting brackets 26 can include many types of connectors whose compositions are frequently made of plastic but can be comprised of any other insulating material. By placing the discharge means 24 within the focus of the parabola of the reflecting screen 22, the flow of ozone can be directed to a site intended for sterilization.

FIG. 4 shows a first embodiment of the ozone generator in which the discharge means 24 is enclosed within a discharge housing 54. A switch 48 is connected to a high frequency converter 58 that joins to the power supply 20 and the discharge means 24. In the embodiment shown in FIG. 4, the power supply 20 is line current from an electrical network. A light emitting diode 50 is also connected to the high frequency converter 58 and indicates the operation of the ozone generator. A source of oxygen can be attached to an inlet 62 so that ozone can be generated as the oxygen passes through the discharge means 24. Alternatively, the inlet 62 can be attached directly to the dielectric element 34 when using an embodiment of the invention with a hollow dielectric element, such as one with an internal electrode 32. The ozone exits the ozone generator through a sterilizing tip 64 which is constructed so that a variety of objects can be attached and sterilized. Objects which can be attached to the sterilizing tip 64 of this embodiment include catheters, tubing, needles, bottles, and syringes. The sterilization of many other items can be achieved by this embodiment and the sterilizing tip 64 can be modified by one of skill in the art to accommodate a multitude of medical devices.

Alternatively, as shown in FIG. 5 (embodiment 2) mounting brackets 26 and a protective shield 38 secure the discharge means 24 to a reflecting screen 22 shaped like a lid to a container. By placing this embodiment of the ozone generator over a matching container, items placed inside the container can be sterilized. According to this aspect of the present invention, an upper compartment 56 of the ozone generator houses a switch 48 joined to the timer 46, a light emitting diode 50, and a high frequency converter 58 (shown in phantom lines) joining the power source 20 and the discharge means 24. In this case, the power supply 20 is line current from an electrical network. The discharge means 24 is mounted in a lower compartment 60 of the ozone generator, and the reflecting screen 22 forms a barrier between the two compartments. By opening the switch 48, the timer 46 is set, and current from the power supply 20 is transferred through the high frequency converter 58 to the electrodes 32 and 36 and the light emitting diode 50. The light emitting diode indicates that the ozone generator is in operation. When the set time expires, the current to the high frequency converter 58, electrodes 32 and 36, and the light emitting diode 50 is removed.

The ozone generator illustrated in FIG. 6 is constructed similarly to the embodiment shown in FIG. 5 but takes the shape of a clothes hanger and provides a means to sterilize articles of clothing. As described above, the power supply 20 (shown in phantom lines), switch 48 (not shown), timer 46 (shown in phantom lines), high frequency converter 58, and light emitting diode 50 are isolated from the discharge means 24 by a barrier created by the reflecting screen 22. In this case, the power supply 20 is a battery.

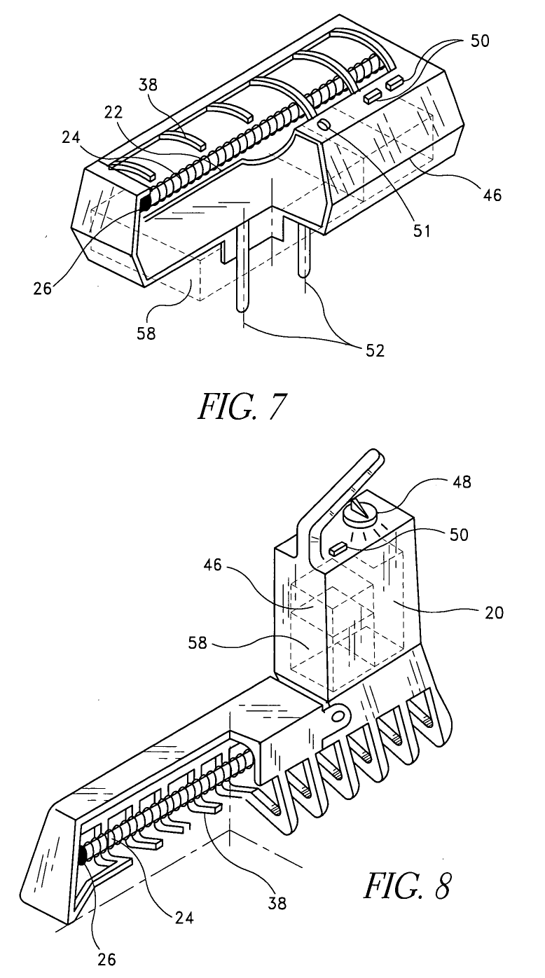

Although the embodiment set forth in FIG. 7 is fabricated in much the same manner as the ozone generators described above, an adapter 52 attached to the high frequency converter 58 enables a user to draw current directly from an electrical outlet. A photo-cell 51 allows for automatic on/off switching depending on the light level. For example, the ozone generator can be set to run automatically at night. The ozone generator pictured in FIG. 7 provides an efficient and economical means to deodorize or sanitize a room.

The apparatus shown in FIG. 8 can be used to deodorize shoes. This ozone generator is constructed in the same manner as the embodiments shown in FIGS. 5-7 but it is shaped so that the apparatus can be placed in a shoe.

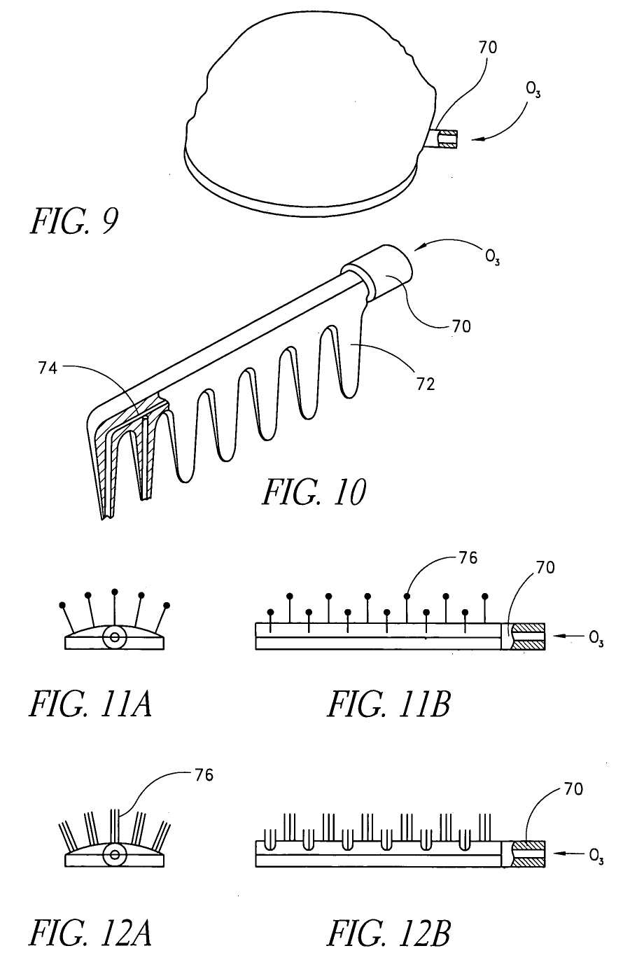

FIG. 9 shows a cap for hair treatment which can be joined to the housing of the ozone generator shown in FIG. 4 in place of the sterilizing tip 64 through an intermediate unit 70. The stream of ion-rich air is supplied to the cap through the intermediate unit 70, after the cap is placed on the head. The gently circulating stream of ozone removes excessive hair moisture and grease, refreshes the hair, and improves hair health. The shapes and sizes of the caps may vary.

FIG. 10 shows a comb for hair maintenance (cleaning, deodorizing, improving the health condition) comprising channels 74 for the supply of a stream of gently ion-rich air to a plurality of comb teeth 72. The ion generator silently creates a concentrated stream of electronically charged ions that neutralize stale, lingering odors, like cigarette smoke. The stream of ion-air is conducted from the ozone generator shown in FIG. 4 through the intermediate unit 70. The ozone generator is activated with the switch 48 on the housing of the ozone generator of FIG. 4.

FIGS. 11A and B and 12A and B show attachments that can be attached to the ozone generator of FIG. 4 through intermediate unit 70. The attachments are used as: 1) a massaging brush for conditioning, fluffing, and styling the hair of men and women (FIGS. 11A and 11B); 2) a brush for maintenance of dog and cat hair, permitting the brushing away of unpleasant odors and refreshing dog and cat hair (FIGS. 12A and 12B). The brushes comprise a handle, common for both brushes, and flexible massage elements 76 permitting the improvement of the hair health and appearance. The effect is achieved by supplying the stream of ion-rich air through the orifices (not shown in Figure) in the housing of the brushes to the massage elements 76. The ion-rich air is supplied to the brush by switching the ozone generator with the switch 48 on the housing of ozone generator (FIG. 4).

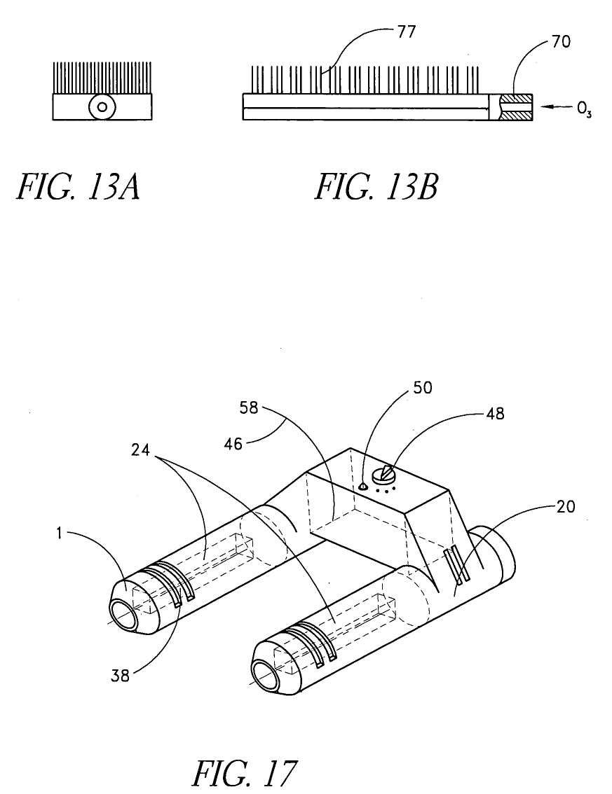

FIGS. 13A and 13B show a clothes brush attachment for the ozone generator of FIG. 4 with flexible elements 77 manufactured, for instance, of plastic. The brush is intended for removing odors from clothes. The silently concentrated stream of odor-neutralizing ozone through the brush head cleans the cloth and penetrates a wide variety of fabrics to remove lingering odors such as cigarette smoke, dog odors, etc. The ozone supply from the ozone generator (FIG. 4) is attached to the clothes brush through the intermediate unit 70. The gentle ozone stream is supplied by activating the switch 48 on the housing of the ozone generator of FIG. 4.

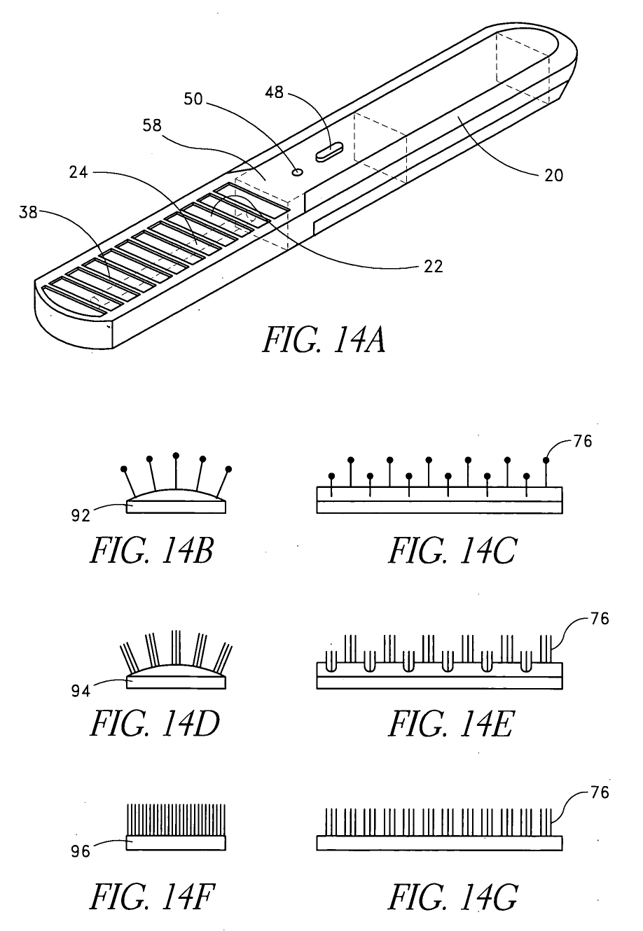

FIGS. 14A-G show an ozone generator intended for various functions and equipped with removable attachments, a brush 92—for hair maintenance of men and women, and a brush 94 for maintenance of dog or cat hair. The second 96 is a brush for clothes cleaning (in analogy with FIG. 13). The ozone generator comprises a housing, discharge means 24 (in phantom lines), a light emitting diode 50, battery power supply 20, high-frequency converter 58, switch 48, protective shield 38, and reflecting screen 22. The attachment 96 contains flexible cleaning elements 76 (in analogy with FIGS. 11 and 12). The ozone generator silently supplies a concentrated stream of odor-neutralizing ozone through the brush head to the subject for cleaning/refreshing of hair or clothes.

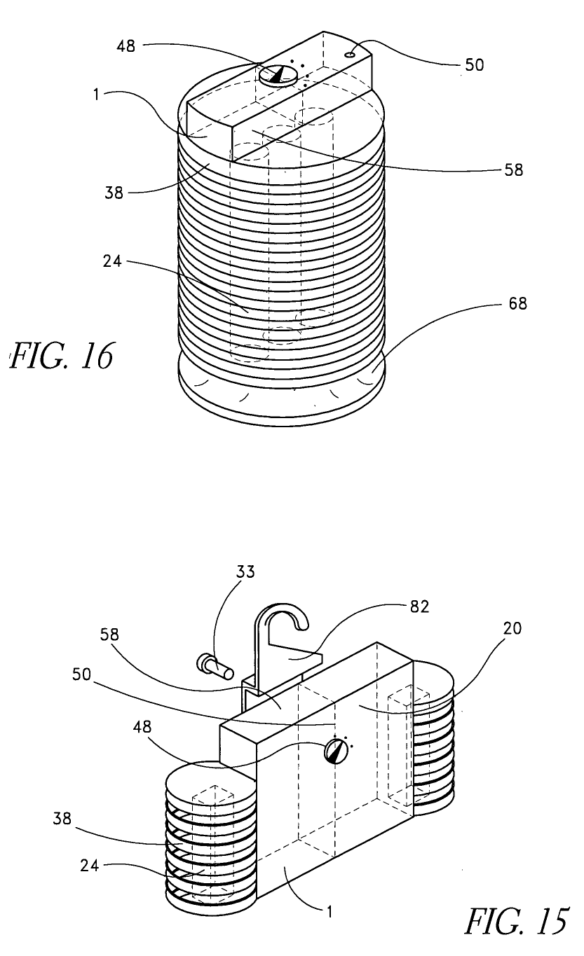

FIG. 15 shows an suspended unit ozone generator which serves as an air freshening/odor neutralizing unit in rooms or wardrobes and which may hang where it is needed. The unit comprises a housing 1, a discharge element 24 (shown in phantom lines), protective shield 38, switch 48, light emitting diode 50, high-frequency converter 58, battery-type power supply 20, removable hook 82 joined to the housing by a connector 33 of any type. The silently circulating natural ozone is supplied to gently neutralize lingering odors in closets, wardrobes, kitchens, or other rooms to remove the unpleasant smell of perspiration, tobacco smoke, dog odors and to neutralize any irritating residual chemicals from rooms and clothes.

FIG. 16 shows a floor variant of the ozone generator of FIG. 15 for air refreshing/odor neutralizing in various rooms. It comprises a housing 1, base 68, discharge means 24 (shown in phantom lines), protective shield 38, high-frequency converter 58, light emitting diode 50, and reflecting screen (not shown in FIG. 16). Power for the unit is supplied from an electric circuit, either 220 or 110 volts.

FIG. 17 shows a design variant of the ozone generator of FIG. 8 for deodorizing shoes. The ozone generator of FIG. 17 comprises a housing 1, two discharge elements 24 (shown in phantom lines), a high-frequency converter 58, battery-type power supply 20, a switch 48, a timer 46, a protective shield 38, and a reflecting screen (not shown in Figure). The ozone generator of FIG. 17 is constructed in the same manner as the embodiments shown in FIGS. 5-7 but is shaped so that the apparatus is to be placed in the pair of shoes. The ozone generator is inserted into both shoes and the switch 48 is turned on. The silent stream of refreshing ozone removes odors and moisture, sanitizing the shoes by oxidizing fungus, bacteria, etc. The refreshing occurs within the entire internal volume of shoes. The time period required is determined in accordance with the length of time the shoes have been worn and the physiological features (odor, moisture, etc.) of the feet, etc.

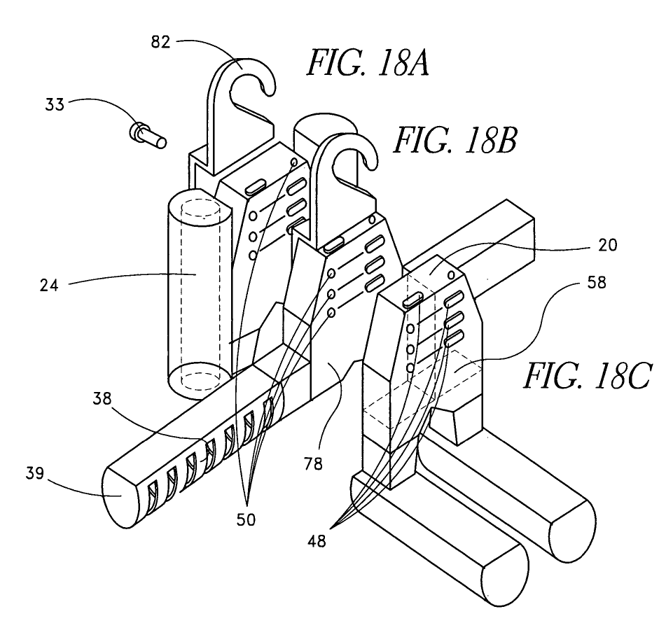

FIG. 18 shows a multipurpose ozone generator variant which can be converted into three variants for ozonizing:

first variant (FIG. 18A) for ozonizing rooms or clothes in wardrobes;

second variant (FIG. 18B) for ozonizing clothes in wardrobes;

third variant—(FIG. 18C)—for ozonizing the shoes.

The multipurpose ozone generator comprises a housing convertible into three different variants by turning the two lateral units 39. The multipurpose ozone generator additionally comprises two discharge means 24 (shown in phantom lines), the high-frequency converter 58, battery-type power supply 20, light emitting diode 50, switch 48, removable hook 82, joined to the stable unit 78 of the housing by a connector 33, protective shield 38, and reflecting screen (not shown in Figure). The source of ozone is located in the stable unit 78. The lateral units 39 are rotatable through a junction (hinged, ball-type, etc.) (not shown in the Figure), where one type of unit can be converted into another type of ozone generator with a different function. The conversion is done by rotating the two lateral units 39.

The ozone generator of FIG. 18A serves for odor neutralizing, refreshing air from cooking, pet odor, tobacco smoke, mite allergens, etc. in rooms or in clothes closets. In this variant, the lateral units 39 are located next to the lateral sides of the stable unit 78 to form a compact housing. The ozone generator of this variant may be placed on the floor of rooms, or suspended anywhere by means of the hook 82. The operation of this ozone generator begins when the battery power supply 20 is activated.

The ozone generator of the second function (FIG. 18B) takes the shape of a clothes hanger and serves to neutralize odors on clothes in wardrobes. The units 39 are rotated (at right or any other angle) to the opposite sides of the unit 78, forming the shape of a hanger. The operation of this ozone generator is similar to the ozone generator shown in FIG. 6.

The ozone generator of the third variant (FIG. 18C) takes the shape of a shoes freshener after the rotation of the lateral units 39. The lateral units 39 are separated (at right or any other angle) in a forward direction, forming two legs to be placed into footwear of all type—boots, dress shoes, slippers, etc. The operation of this ozone generator is similar to the ozone generator shown in FIG. 8.

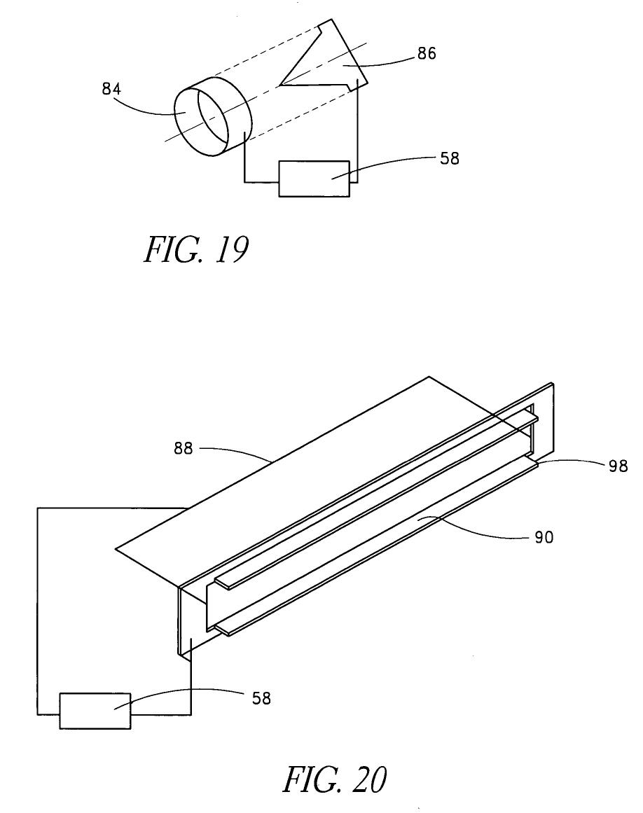

FIGS. 19 and 20 show possible variants of the discharge elements which may be used in all construction variants of ozone generators (FIGS. 4-18). The discharge element of FIG. 19 comprises two electrodes 84 and 86 and the high voltage converter 58. The electrode 84 has the shape of a ring, and the electrode 86 has the shape of a plate with a sharpened tip. The electrode 84 in the shape of a ring allows for directed electrical flow through the hollow ring to concentrate the flow of ozone at the outlet of the ozone generator. The electrodes may be manufactured of any current-carrying material, including, but not limited to, stainless steel, nickel-chromium alloy, tungsten, molybdenum, or any suitable metal. The electrodes may be coated with a dielectric coating, such as ceramic, glass, or glass enamel. If the electrode has a dielectric coating, the surface of the dielectric coating must be rough.

If a dielectric coating is present on the electrode, it serves to stabilize the electric discharge between the electrodes and insures the saturation of room air with the microelements of the dielectric coating. Saturating the room air with the microelements for improves or treats the room air.

The electrodes may also be manufactured of dielectric material, such as ceramic, glass, or glass enamel. If the electrodes are manufactured from dielectric material, the dielectric serves as the base of the electrode, and the dielectric is coated with metal. Suitable metals for forming the metal coat include stainless steel, nickel-chromium alloy, tungsten, molybdenum, or any suitable metal. Forming the electrodes from dielectric material simplifies the manufacture of the electrodes and is more economical than forming the electrodes from metal.

The discharge element shown in FIG. 20 comprises two electrodes 88, 90 and the high-frequency converter 58. The electrode 88 has the shape of a current-carrying filament, and the electrode 90 has the shape of a plate with a elongated slot. Two elongated metal strips flaps 98 extend axially from the plate at approximately right angles to the surface of the plate in the direction away from the electrode 88 in the shape of a filament. The length of the metal strips is approximately the same as the length of the elongated slot, and the combined widths of the two elongated metal strips is approximately the same as the width of the elongated slot. The electrodes 88 and 90 of FIG. 20 may be made of the same materials as the electrodes 84 and 86 of FIG. 19.

When the electrodes 88 and 90 are activated, the electrical flow is directed through the elongated slot, providing a concentrated flow of ozone through the elongated slot to the output of the ozone generator.

The discharge elements of FIGS. 19 and 20 may be inserted into the housings of all above-mentioned ozone generators in similar manner to the first and second electrodes 32 and 36. The directed concentrated electric convention flow of the electrodes illustrated in FIGS. 19 and 20 allows for improved efficiency of the ozone generators utilizing the electrodes.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

What is claimed is:

1. An apparatus for generating ozone comprising:
a housing comprising a central unit and two lateral units attached to the central unit through rotatable joints; and
a discharge means in at least one of said lateral units, said discharge means comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and a power supply connected to the first and second electrodes; wherein said lateral units rotate on the rotatable joints to form ozone generators having different shapes and functions.

2. The apparatus of claim 1, wherein said lateral units are rotated close to the central unit to form an ozone generator for room deodorizing.

3. The apparatus of claim 1, additionally comprising a hook on said central unit, wherein said lateral units are rotated outward from said central unit to form an ozone generator in the shape of a clothes hanger for clothes freshening.

4. The apparatus of claim 1, wherein said lateral units are rotated forward to form a ozone generator to be inserted into shoes for freshening and deodorizing the shoes.

5. The apparatus of claim 1, wherein discharge means are in both of said lateral units.

6. A method for treating hair on the head of a human, comprising:
providing an ozone generator comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and
a tubular shaped reflecting screen that connects at a first end to an inlet that can be joined to a source of an oxygen containing gas and at a second end to an intermediate unit;
attaching a cap to the second end of the tubular shaped reflective screen through the intermediate unit;
placing the cap over the hair;
joining a source of an oxygen containing gas to the inlet;
energizing the first and second electrodes with electrical power to generate the electrical discharge; and
passing an oxygen containing gas through the electrical discharge so as to generate ozone, said ozone passing through the intermediate unit into the cap and over the hair, thereby treating the hair.

7. A method for hair maintenance, comprising:
providing an ozone generator comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and
a tubular shaped reflecting screen that connects at a first end to an inlet that can be joined to a source of an oxygen containing gas and at a second end to an intermediate unit;
attaching a comb having teeth to the second end of the tubular shaped screen through the intermediate unit, wherein said comb has one or more channels leading from the intermediate unit to the teeth on the comb;
joining a source of an oxygen containing gas to the inlet;
energizing the first and second electrodes with electrical power to generate the electrical discharge; and
passing an oxygen containing gas through the electrical discharge so as to generate ozone, said ozone passing through the intermediate unit into the channels in the comb and the teeth of the comb; and
combing the hair with the comb.

8. A method for maintaining hair on humans, dogs, or cats, comprising:
providing an ozone generator comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and
a tubular shaped reflecting screen that connects at a first end to an inlet that can be joined to a source of an oxygen containing gas and at a second end to an intermediate unit;
attaching a massage brush with flexible massage elements to the second end of the tubular shaped reflecting screen through the intermediate unit, wherein one or more channels inside the massage brush extend from the intermediate unit to the flexible massage elements;
joining a source of an oxygen containing gas to the inlet;
energizing the first and second electrodes with electrical power to generate the electrical discharge; and
passing an oxygen containing gas through the electrical discharge so as to generate ozone, said ozone passing through the intermediate unit into the channels inside the massage brush to the flexible massage elements; and
brushing the hair of the human, dog, or cat, thereby maintaining the hair.

9. A method for cleaning or refreshing clothes, comprising:
providing an ozone generator comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and
a tubular shaped reflecting screen that connects at a first end to an inlet that can be joined to a source of an oxygen containing gas and at a second end to an intermediate unit;
attaching a clothes brush with flexible cleaning elements to the second end of the tubular shaped reflecting screen through the intermediate unit, wherein one or more channels inside the clothes brush extend from the intermediate unit to the flexible cleaning elements;
joining a source of an oxygen containing gas to the inlet;
energizing the first and second electrodes with electrical power to generate the electrical discharge; and
passing an oxygen containing gas through the electrical discharge so as to generate ozone, said ozone passing through the intermediate unit into the channels inside the clothes brush to the flexible cleaning elements; and
brushing the clothes with the clothes brush, thereby cleaning or refreshing the clothes.

10. A method for maintaining hair of men, women, dogs or cats, comprising:
providing an ozone generator comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and
a tubular shaped reflecting screen that connects at a first end to an inlet that can be joined to a source of an oxygen containing gas and at a second end to flexible cleaning elements, joining a source of an oxygen containing gas to the inlet;
energizing the first and second electrodes with electrical power to generate the electrical discharge; and
passing an oxygen containing gas through the electrical discharge so as to generate ozone;
supplying the oxygen containing gas and ozone to the flexible cleaning elements; and
brushing the hair with the flexible cleaning elements.

11. The method of claim 10, wherein said apparatus additionally comprises a battery power supply, and a high voltage converter.

12. A method for deodorizing a room or refreshing the clothes in a wardrobe, comprising:
providing an ozone generator comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and
a reflecting screen of parabolic shape, attached to the dielectric element; and
a hook to suspend the ozone generator on the room wall or in the wardrobe;
suspending the ozone generator on the room wall or in the wardrobe from the hook;
energizing the first and second electrodes with electrical power to generate an electrical discharge; and
passing an oxygen containing gas through the electrical discharge so as to generate ozone.

13. The method of claim 12, wherein the hook is removable.

14. A method for deodorizing a room comprising:
providing an ozone generator comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element;
a reflecting screen of parabolic shape, attached to the dielectric element; and
a base for placing the ozone generator on the floor;
placing the ozone generator on the floor in the room;
energizing the first and second electrodes with electrical power to generate an electrical discharge; and
passing an oxygen containing gas through the electrical discharge so as to generate ozone.

15. A method for sanitizing shoes comprising:
providing an ozone generator comprised of a housing comprising two parallel cylinders, wherein each cylinder contains a discharge element comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and
a reflecting screen of parabolic shape, attached to the dielectric element;
placing the ozone generator in the shoes;
energizing the first and second electrodes with electrical power to generate an electrical discharge; and
passing an oxygen containing gas through the electrical discharge so as to generate ozone.

16. A method for generating ozone for multipurpose use comprising:
providing an ozone generator comprising:
a housing comprising a central unit and two lateral units attached to the central unit through rotatable joints; and
a discharge means in at least one of said lateral units, said discharge means comprising:
a dielectric element of rectangular cross-section having a rough surface;
a plurality of flanges joined to the dielectric element;
a first electrode comprised of a plurality of electrically conductive helical windings in contact with the flanges;
a second electrode comprised of an electrically conductive coating which overlies the rough surface of the dielectric element; and
a power supply connected to the first and second electrodes;
wherein said lateral units rotate on the rotatable joints to form ozone generators having different shapes and functions;
rotating said lateral units to form an ozone generator of the desired configuration;
energizing the first and second electrodes with electrical power to generate an electrical discharge; and
passing an oxygen containing gas through the electrical discharge so as to generate ozone.

17. An apparatus for generating ozone from an electrical discharge in an oxygen containing gas, the apparatus comprising:
a first electrode in the shape of a ring; and
a second electrode comprising a plate with a sharpened tip, wherein said plate is made from a current-carrying material and wherein said sharpened tip points toward said first electrode.

18. The apparatus according to claim 17, further comprising a high frequency power converter and a power supply.

19. An apparatus for generating ozone from an electrical discharge in an oxygen containing gas, the apparatus comprising:
a first electrode comprising a current-carrying filament; and
a second electrode comprising a plate having an elongated slot therein and two elongated strips extending axially from the plate at approximately right angles in a direction away from the first electrode.

20. The apparatus according to claim 19, further comprising a high frequency power converter and a power supply.
